(19) United States
(12) Patent Application Publication
(10) Pub. No.: US 2024/0430851 A1
(43) Pub. Date: Dec. 26, 2024

(54) SYSTEMS AND METHODS FOR AUTHORIZATION CONFIGURATION IN DEVICE-TO-DEVICE COMMUNICATIONS

(71) Applicant: ZTE Corporation, Shenzhen (CN)

(72) Inventors: Jiajun CHEN, Shenzhen (CN); Dapeng LI, Shenzhen (CN); Yin GAO, Shenzhen (CN); Yansheng LIU, Shenzhen (CN)

(73) Assignee: ZTE Corporation, Shenzhen (CN)

(21) Appl. No.: 18/680,704

(22) Filed: May 31, 2024

Related U.S. Application Data
(63) Continuation of application No. PCT/CN2022/112295, filed on Aug. 12, 2022.

(51) Int. Cl. H04W 64/00; H04W 12/08; H04W 76/14

(52) U.S. Cl. CPC H04W 64/003; H04W 12/08; H04W 76/14

(57) ABSTRACT

The present disclosure relates to wireless communications, including receiving, by a Base Station (BS), authorized information for at least one of ranging or Sidelink (SL) positioning service for a first wireless communication device and storing, by the BS, the authorized information in a device context for the first wireless communication device.

### CROSS-REFERENCE TO RELATED APPLICATION

This application claims the benefit of priority under 35 U.S.C. § 120 as a continuation of PCT Patent Application No. PCT/CN2022/112295, filed on Aug. 12, 2022, the disclosure of which is incorporated herein by reference in its entirety.

### TECHNICAL FIELD

The disclosure relates generally to wireless communications and, more particularly, to authorization configuration in device-to-device communications.

### BACKGROUND

Sidelink (SL) communication refers to wireless radio communication between two or more User Equipments (UEs). In this type of communications, two or more UEs that are geographically proximate to each other can communicate without being routed to a Base Station (BS) or a core network. Data transmissions in SL communications are thus different from typical cellular network communications that include transmitting data to a BS and receiving data from a BS. In SL communications, data is transmitted directly from a source UE to a target UE through, for example the Unified Air Interface (e.g., PC5 interface) without passing through a BS.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, systems, methods, apparatuses, and non-transitory computer-readable media include receiving, by a BS, authorized information for at least one of ranging or SL positioning service for a first UE and storing, by the BS, the authorized information in a device context for the first UE.

In some arrangements, systems, methods, apparatuses, and non-transitory computer-readable media include sending, by an entity to a BS, authorized information for at least one of ranging or SL positioning services for a first wireless communication device. The BS stores the authorized information in a device context for the first wireless communication device. In some examples, the entity receives from the BS a response to a message containing the authorized information. In some examples, the entity receives from the BS a request for the authorized information

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication network, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communication, according to various arrangements.

FIG. 3 is a diagram illustrating a core network of a wireless communication systems, according to various arrangements.

FIG. 4 is a flowchart diagram illustrating an example method for managing authorized information for at least one of ranging or SL positioning service in SL communications for a UE during registration, according to various arrangements.

FIG. 5 is a flowchart diagram illustrating an example method for managing authorized information for at least one of ranging or SL positioning service in SL communications for a UE during subscriber data update, according to various arrangements.

FIG. 6 is a flowchart diagram illustrating an example method for managing authorized information for at least one of ranging or SL positioning service in SL communications for a UE during handover procedure, according to various arrangements.

FIG. 7 is a flowchart diagram illustrating an example method for managing authorized information for at least one of ranging or SL positioning service in SL communications for a UE during handover procedure, according to various arrangements.

FIG. 8 is a flowchart diagram illustrating an example method for managing authorized information for at least one of ranging or SL positioning service in SL communications for a UE during handover procedure, according to various arrangements.

FIG. 9 is a flowchart diagram illustrating an example method for managing authorized information for at least one of ranging or SL positioning service in SL communications for a UE during a retrieve UE context procedure, according to various arrangements.

FIG. 10 is a flowchart diagram illustrating an example method for managing authorized information for at least one of ranging or SL positioning service in SL communications for a UE, according to various arrangements.

FIG. 11 is a flowchart diagram illustrating an example method for managing authorized information for at least one of ranging or SL positioning service in SL communications for a UE, according to various arrangements.

FIG. 12 is a flowchart diagram illustrating an example method for managing authorized information for at least one of ranging or SL positioning service in SL communications for a UE, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional BS-centric cellular networks have limited high data rate capabilities and support for proximity services. In this context, device-to-device (D2D) communications emerge to address the shortcomings of the BS-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

To improve the reliability, data rate, latency of SL communications, Carrier Aggregation (CA) can be implemented for SL communications. In CA, two or more Component Carriers (CCs) are aggregated in order to support wider transmission bandwidths in the frequency domain. In some examples, a vehicle UE can simultaneously perform SL reception and transmission on one or multiple CCs. The arrangements disclosed herein relate to data split and data duplication based on CA.

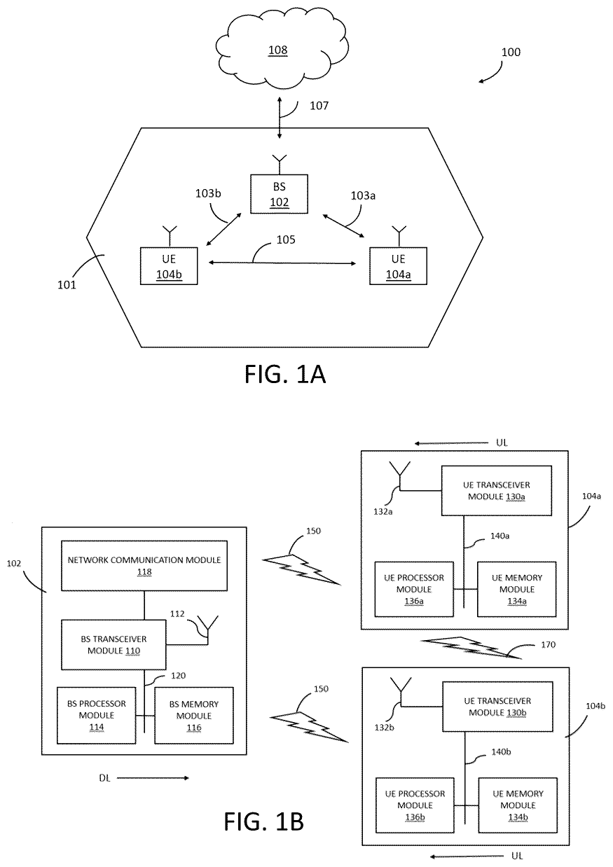

Referring to FIG. 1A, an example wireless communication network 100 is shown. The wireless communication network 100 illustrates a group communication within a cellular network. In a wireless communication system, a network side communication node or a BS can include a next Generation Node B (gNB), an E-UTRAN Node B (also known as Evolved Node B, eNodeB or eNB), a pico station, a femto station, a Transmission/Reception Point (TRP), an Access Point (AP), a Next Generation Radio Access Network (NG-RAN) node, an Next Generation eNB (NG-eNB), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In FIG. 1A, a network side and a terminal side communication node are represented by a BS 102 and UEs 104a and 104b, respectively. In some arrangements, the BS 102 and UEs 104a/104b are sometimes referred to as “wireless communication node” and “wireless communication device,” respectively. Such communication nodes/devices can perform wireless communications.

In the illustrated arrangement of FIG. 1A, the BS 102 can define a cell 101 in which the UEs 104a and 104b are located. The UEs 104a and/or 104b can be moving or remain stationary within a coverage of the cell 101. The UE 104a can communicate with the BS 102 via a communication channel 103a. Similarly, the UE 104b can communicate with the BS 102 via a communication channel 103b. In addition, the UEs 104a and 104b can communicate with each other via a communication channel 105. The communication channels 103a and 104b between a respective UE and the BS can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V21) communications, Vehicle-to-Network (V2N) communications, or the like. In some instances, vehicle network communications modes can be collective referred to as Vehicle-to-Everything (V2X) communications. The BS 102 is connected to Core Network (CN) 108 through an external interface 107, e.g., an Iu interface.

In some examples, a remote UE (e.g., the UE 104b) that does not directly communicate with the BS 102 or the CN 108 (e.g., the communication channel link 103b is not established) communicates indirectly with the BS 102 and the CN 108 using the SL communication channel 105 via a relay UE (e.g., the UE 104a), which can directly communicate with the BS 102 and the CN 108 or indirectly communicate with the BS 102 and the CN 108 via another relay UE that can directly communicate with the BS 102 and the CN 108.

FIG. 1B illustrates a block diagram of an example wireless communication system for transmitting and receiving downlink, uplink and SL communication signals, in accordance with some arrangements of the present disclosure. In some arrangements, the system can transmit and receive data in a wireless communication environment such as the wireless communication network 100 of FIG. 1A, as described above.

The system generally includes the BS 102 and UEs 104a and 104b, as described in FIG. 1A. The BS 102 includes a BS transceiver module 110, a BS antenna 112, a BS memory module 116, a BS processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The BS 102 communicates with the UEs 104a and 104b via one or more of a communication channel 150, which can be any wireless channel or other medium known in the art suitable for transmission of data as described herein.

The system may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the BS 102 is known as an uplink transmission, and a wireless transmission from an antenna of the BS 102 to an antenna of one of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the BS transceiver module 110 may be herein referred to as a downlink transceiver, or BS transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the BS 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the BS transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the BS transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the BS transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the BS 102 that enable bi-directional communication between BS transceiver 110 and other network components and communication nodes configured to communication with the BS 102. For example, the network interface 118 may be configured to support internet or WiMAX traffic. In a typical deployment, without limitation, the network interface 118 provides an 802.3 Ethernet interface such that BS transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the BS 102 to communicate with other BSs or core network over a wired or wireless connection.

In some arrangements, each of the UEs 104a and 104b can operate in a hybrid communication network in which the UE communicates with the BS 102, and with other UEs, e.g., between 104a and 104b. As described in further detail below, the UEs 104a and 104b support SL communications with other UE's as well as downlink/uplink communications between the BS 102 and the UEs 104a and 104b. In general, the SL communication allows the UEs 104a and 104b to establish a direct communication link with each other, or with other UEs from different cells, without requiring the BS 102 to relay data between UEs.

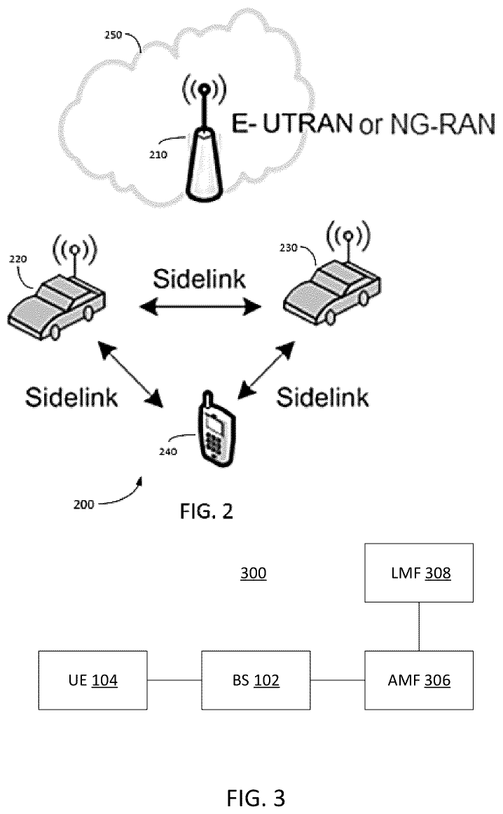

FIG. 2 is a diagram illustrating an example system 200 for SL communication, according to various arrangements. As shown in FIG. 2, a BS 210 (such as BS 102 of FIG. 1A) broadcasts a signal that is received by a first UE 220, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the BS 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX) UE, and the UE that is receiving said data is referred to as the reception (RX) UE.

In some examples, a BS may not support SL CA. For example, a BS may not be able to schedule SL resources on multiple carrier or cannot provide SL configurations for multiple carriers. Some arrangements disclosed herein relate to the UE determining whether a BS supports SL CA.

Referring to FIG. 3, a system 300 is shown, according to some arrangements. The UE 104 (which can be either UE 104a or 104b) can be communicatively connected to the BS 102 or 220, e.g., via the channel 103a 103b, or 150. The BS 102 is connect via suitable wired or wireless connection to a core network, including an Access and Mobility Management function (AMF) 306 and Location Management Function (LMF) 308. The AMF 306 receives requests and handles connection or mobility management. For example, the AMF 306 sends location service requests to the LMF 308. The LMF 308 can process the location services request and returns a result of the location service back to the AMF 306. The AMF 306 can return the location service back to the BS 102. In some examples, each of the AMF 306 and the LMF 308 can be performed using one or more systems having a processor and a memory. Each of the AMF 306 and LMF 308 can be implemented using at least one server or computing systems separate from the BS 102 and the UE 104.

In some implementations, the UE can operate in either a scheduled resource allocation mode or a UE autonomous resource selection mode for resource allocation in SL communications. The modes also apply to at least one of ranging or SL positioning service. In the scheduled resource allocation mode, service authorized information needs to be provisioned to the BS 102 so that the BS 102 can support ranging and SL positioning. In order to enable ranging-based services and SL positioning over PC5, the service authorization related to SL positioning to the BS 102 is provided to allow the BS 102 to allocate resource to the UE for ranging and SL positioning operations.

In some examples, ranging-based services and SL positioning are supported for in-coverage, partial coverage, and out-of-network coverage. In order to allow the UE to operate in either scheduled resource allocation mode or UE autonomous resource selection mode for resource allocation in SL, service authorized information needs to be provisioned to BS 102 for the support of ranging and SL positioning. To enable ranging-based services and SL positioning over PC5 (e.g., the interface for the channel 105 or 150 between UEs 104a and 104b), the service authorization related to SL positioning to BS 102 can be determined so that the network can allocate resources to the UE for the ranging and SL positioning operation.

In some implementations, during the registration procedure for a UE, the UE includes SL interface capabilities (e.g., PC5 capability) for at least one of ranging or SL positioning service in the registration request message. The AMF 306 obtains the information for the ranging-based services and SL positioning. The PC5 Capability for Ranging/SL positioning indicates whether the UE is capable of ranging and/or SL positioning over PC5 reference point.

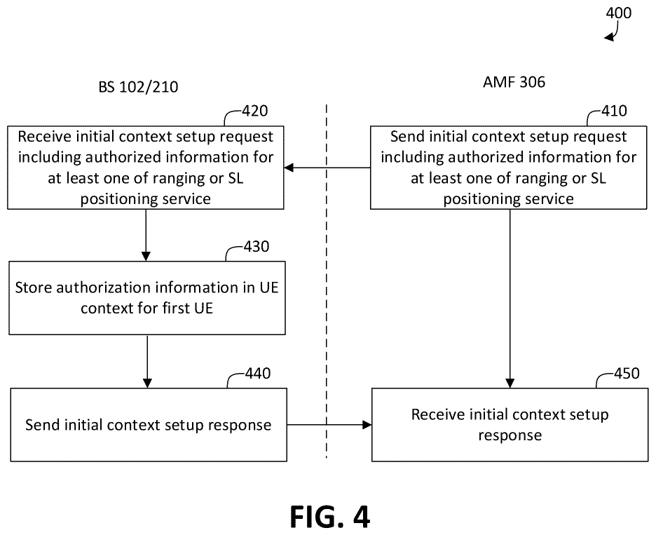

FIG. 4 is a flowchart diagram illustrating an example method 400 for managing authorized information for at least one of ranging or SL positioning service in SL communications for a UE during registration, according to various arrangements. Referring to FIGS. 1A-4, the method 400 can be performed by a BS (e.g., the BS 102 or 210) and an AMF (e.g., the AMF 306). Communication network or connection between the BS and the AMF is shown as the dashed line therebetween. In some examples in which a first UE (e.g., the UE 104a or 220) is capable of SL communications (e.g., PC5-capable) for at least one of ranging or SL positioning service, and the first UE is authorized to use at least one of ranging or SL positioning service over a PC5 reference point based on the subscription data, the AMF sends information related to the at least one of ranging or SL positioning service to the BS over an initial context setup request message during registration of the first UE. The first UE and a second UE (e.g., the UE 104b or 230) can communicate via SL communications.

For example, at 410, the AMF sends to the BS an initial context setup request including authorized information for at least one of ranging or SL positioning service. At 420, the BS receives from the AMF the initial context setup request including the authorized information for the at least one of ranging or SL positioning service.

In some implementations, the authorized information includes at least one of at least one of ranging or SL positioning service authorization indication for the first UE, ranging and/or SL positioning resource management parameter for the first UE, ranging and/or SL positioning Quality of Service (QOS) parameter for the first UE, or a type of the first UE for at least one of ranging or SL positioning service.

In some examples, the ranging and SL positioning service authorization indication indicates whether the at least one of ranging or SL positioning service is authorized or unauthorized for the first UE over a reference point (e.g., the PC5 reference point). The PC5 reference point is a reference point that is between the first UE and the second UE.

In some examples, the ranging and SL positioning resource management parameter can be an authorized ranging and/or SL positioning parameter used by the BS to manage resources for and to schedule PC5 transmissions for at least one of ranging or SL positioning service for the first UE in the network. An example of the ranging and/or SL positioning resource management parameter includes the UE ranging/SL positioning aggregate maximum bit. The UE ranging/SL positioning aggregate maximum bit limits the Aggregate Maximum Bit Rate (e.g., AMBR) expected to be provided across all QoS flows or non-Guaranteed Bit Rate (GRB) QoS flows of a UE.

In some examples, the ranging and SL positioning QoS parameter can be an authorized ranging and/or SL positioning parameter used by the BS to define attributes of the QoS flow of the first UE's SL communication (e.g., with the second UE) for at least one of ranging or SL positioning service. An example of the ranging and/or SL positioning QoS parameter includes a ranging/SL positioning PC5 QoS parameter.

In some examples, the type of the first UE for at least one of ranging or SL positioning service indicates a type or role of the first UE in authorized Ranging/SL positioning of the first UE. Examples of the type include a target UE, a reference UE, an assistant UE, or a network-assisted UE. A target UE indication indicates whether the first UE is authorized to act as a ranging/SL positioning target UE. A reference UE indication indicates whether the first UE is authorized to act as a ranging/SL positioning reference UE. The reference UE may have a known location used in at least one of ranging or SL positioning service of the target UE. An assistant UE indication indicates whether the first UE is authorized to act as a ranging/SL positioning assistant UE. The assistant UE assists in determining the positioning of the target UE, including providing assistance for measurements such as Time Of Arrival (TOA), Angle Of Arrival (AOA), Time Difference Of Arrival (TDOA), Relative Time Of Arrival (RTOA), and so on. A network assisted UE indication indicates whether the first UE is authorized to act as a ranging/SL positioning network assisted UE.

In some examples, in response to receiving the initial context setup request message including the authorized information, the BS stores the received authorized information in the UE context for the first UE, at 430. The BS can use the UE context including the authorized information for the first UE's SL communications in the scheduled resource allocation mode for the ranging/SL positioning services.

At 440, the BS sends to the AMF an initial context setup response in response to the initial context setup request. At 450, the AMF receives from the BS the initial context setup response.

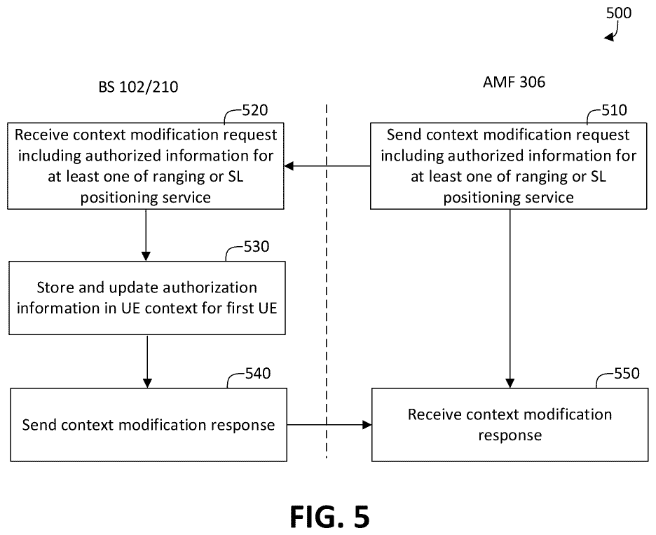

FIG. 5 is a flowchart diagram illustrating an example method 500 for managing authorized information for at least one of ranging or SL positioning service in SL communications for a UE during subscriber data update, according to various arrangements. Referring to FIGS. 1A-5, the method 500 can be performed by a BS (e.g., the BS 102 or 210) and an AMF (e.g., the AMF 306). Communication network or connection between the BS and the AMF is shown as the dashed line therebetween. In some examples in which a first UE (e.g., the UE 104a or 220) is capable of SL communications (e.g., PC5-capable) for at least one of ranging or SL positioning service, and the first UE is authorized to use at least one of ranging or SL positioning service over a PC5 reference point based on the subscription data, the AMF sends information related to the at least one of ranging or SL positioning service of the first UE to the BS over a UE context modification request during subscriber data update or UE context modification. The first UE and a second UE (e.g., the UE 104b or 230) can communicate via SL communications.

For example, at 510, the AMF sends to the BS a context modification request including authorized information for at least one of ranging or SL positioning service. At 520, the BS receives from the AMF the context modification request including the authorized information for the at least one of ranging or SL positioning service.

In some implementations, as described, the authorized information includes at least one of at least one of ranging or SL positioning service authorization indication for the first UE, ranging and/or SL positioning resource management parameter for the first UE, ranging and/or SL positioning QoS parameter for the first UE, or a type of the first UE for at least one of ranging or SL positioning service.

In some examples, in response to receiving the context modification request message including the authorized information, at 530, the BS stores the received authorized information in the UE context for the first UE and updates the previously stored authorized information for the UE (e.g., received at 430 or any previous modification). The BS can use the UE context including the authorized information for the first UE's SL communications in the scheduled resource allocation mode for the ranging/SL positioning services.

At 540, the BS sends to the AMF a context modification response in response to the context modification request. At 550, the AMF receives from the BS the context modification response.

In some examples, in response to determining that the received ranging and/or SL positioning service authorization indication indicates that the at least one of ranging or SL positioning service is not authorized, the BS initiates at least one action to prevent the first UE from accessing any of the at least one of ranging or SL positioning service. For example, the BS does not allocate any SL resource for the UE to perform at least one ranging or SL positioning service. The BS can send to the UE a failure message.

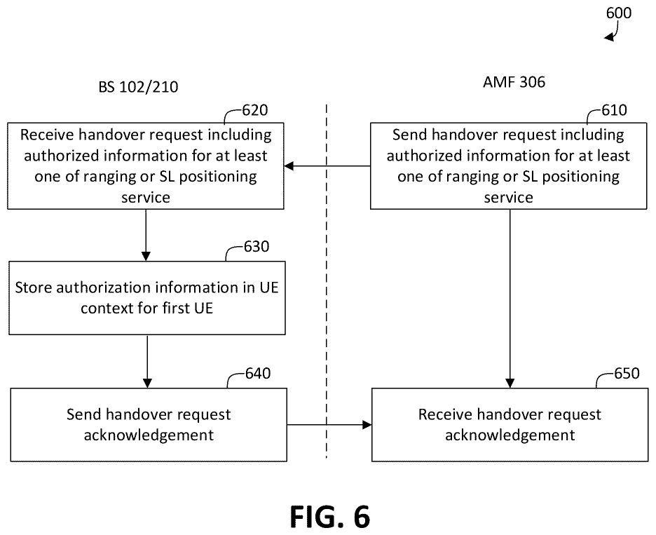

FIG. 6 is a flowchart diagram illustrating an example method 600 for managing authorized information for at least one of ranging or SL positioning service in SL communications for a UE during handover procedure, according to various arrangements. Referring to FIGS. 1A-6, the method 600 can be performed by a BS (e.g., the BS 102 or 210) and an AMF (e.g., the AMF 306). Communication network or connection between the BS and the AMF is shown as the dashed line therebetween. A handover procedure refers to the procedure in which the first UE switches serving BS from a source BS to a target BS. The BS in FIG. 6 is the target BS during a N2-based handover or the inter-Radio Access Technology (RAT) to NG-RAN handover procedures for the first UE. In some examples in which a first UE (e.g., the UE 104a or 220) is capable of SL communications (e.g., PC5-capable) for at least one of ranging or SL positioning service, and the first UE is authorized to use at least one of ranging or SL positioning service over a PC5 reference point based on the subscription data, the AMF sends information related to the at least one of ranging or SL positioning service of the first UE to the BS over a handover request during a handover procedure (e.g., the N2-based handover procedure). The first UE and a second UE (e.g., the UE 104b or 230) can communicate via SL communications.

For example, at 610, the AMF sends to the BS a handover request including authorized information for at least one of ranging or SL positioning service. At 620, the BS receives from the AMF the handover request including the authorized information for the at least one of ranging or SL positioning service.

In some implementations, as described, the authorized information includes at least one of at least one of ranging or SL positioning service authorization indication for the first UE, ranging and/or SL positioning resource management parameter for the first UE, ranging and/or SL positioning QoS parameter for the first UE, or a type of the first UE for at least one of ranging or SL positioning service.

In some examples, in response to receiving the handover request message including the authorized information, at 630, the BS stores the received authorized information in the UE context for the first UE. The BS can use the UE context including the authorized information for the first UE's SL communications in the scheduled resource allocation mode for the at least one of ranging or SL positioning service.

At 640, the BS sends to the AMF a handover request acknowledgement in response to the handover request. At 650, the AMF receives from the BS the handover request acknowledgement.

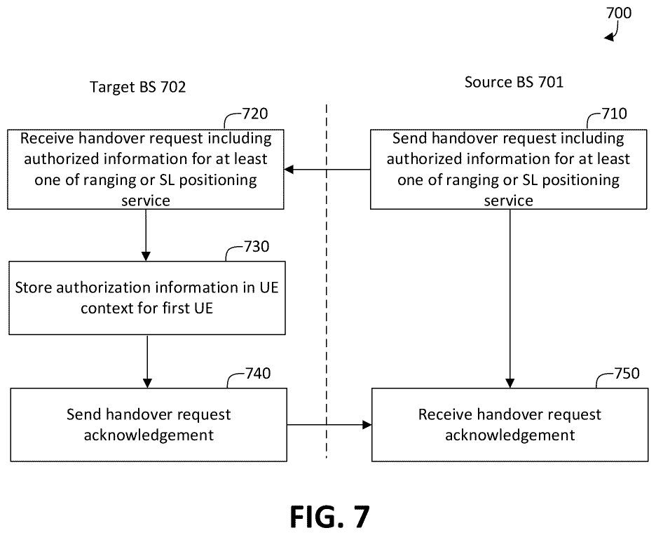

FIG. 7 is a flowchart diagram illustrating an example method 700 for managing authorized information for at least one of ranging or SL positioning service in SL communications for a UE during handover procedure, according to various arrangements. Referring to FIGS. 1A-7, the method 700 can be performed by a source BS 701 and a target BS 702. Each of the BS 701 and 702 can be a BS such as the BS 102 or 210. Communication network or connection between the BS 701 and 702 is shown as the dashed line therebetween. A handover procedure refers to the procedure in which the first UE (e.g., the UE 104a or 220) switches serving BS from the source BS 701 to the target BS 702, during a Xn-based handover over the Xn interface for the first UE. In some examples in which the authorized information for the at least one of ranging or SL positioning service is included in the UE context as stored in the source BS 701, the source BS 701 can send the handover request including the authorized information to the target BS 702. The first UE and a second UE (e.g., the UE 104b or 230) can communicate via SL communications.

For example, at 710, the source BS 701 sends to the target BS 702 handover request including authorized information for at least one of ranging or SL positioning service. At 720, the target BS 702 receives from the source BS 701 the handover request including the authorized information for the at least one of ranging or SL positioning service.

In some implementations, as described, the authorized information includes at least one of at least one of ranging or SL positioning service authorization indication for the first UE, ranging and/or SL positioning resource management parameter for the first UE, ranging and/or SL positioning QoS parameter for the first UE, or a type of the first UE for at least one of ranging or SL positioning service.

In some examples, in response to receiving the handover request message including the authorized information, at 730, the target BS 702 stores the received authorized information in the UE context for the first UE. The target BS 702 can use the UE context including the authorized information for the first UE's SL communications in the scheduled resource allocation mode for the at least one of ranging or SL positioning service.

At 740, the target BS 702 sends to the source BS 701 a handover request acknowledgement in response to the handover request. At 750, the source BS 701 receives from the target BS 702 the handover request acknowledgement.

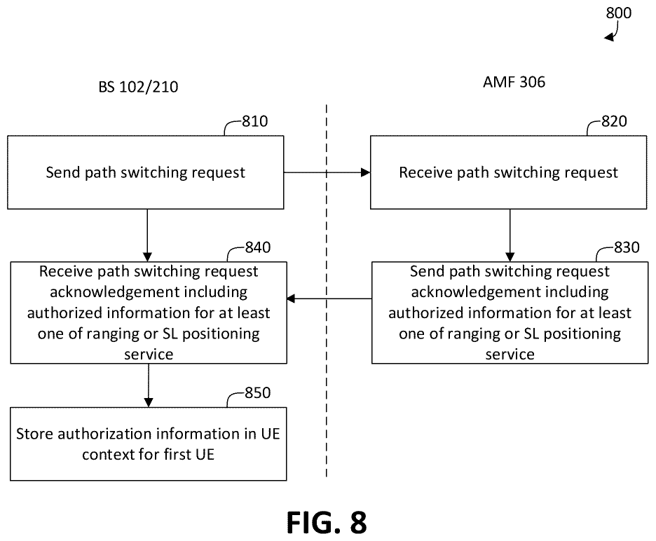

FIG. 8 is a flowchart diagram illustrating an example method 800 for managing authorized information for at least one of ranging or SL positioning service in SL communications for a UE during handover procedure, according to various arrangements. Referring to FIGS. 1A-8, the method 800 can be performed by a BS (e.g., the BS 102 or 210) and an AMF (e.g., the AMF 306). Communication network or connection between the BS and the AMF is shown as the dashed line therebetween. A handover procedure refers to the procedure in which the first UE switches serving BS from a source BS to a target BS. The BS in FIG. 6 is the target BS during an Xn-based handover procedure for the first UE. In some examples in which a first UE (e.g., the UE 104a or 220) is capable of SL communications (e.g., PC5-capable) for at least one of ranging or SL positioning service, and the first UE is authorized to use at least one of ranging or SL positioning service over a PC5 reference point based on the subscription data, the AMF sends information related to the at least one of ranging or SL positioning service of the first UE to the BS over a path switching request acknowledgement during a handover procedure (e.g., the Xn-based handover procedure). The first UE and a second UE (e.g., the UE 104b or 230) can communicate via SL communications.

At 810, the BS sends a path switching request to the AMF. At 820, the AMF receives the path switching request. At 830, in response to receiving the path switching request, the AMF sends to the BS a path switching acknowledgement including authorized information for at least one of ranging or SL positioning service. At 840, the BS receives from the AMF the path switching acknowledgement including the authorized information for the at least one of ranging or SL positioning service.

In some implementations, as described, the authorized information includes at least one of at least one of ranging or SL positioning service authorization indication for the first UE, ranging and/or SL positioning resource management parameter for the first UE, ranging and/or SL positioning QoS parameter for the first UE, or a type of the first UE for at least one of ranging or SL positioning service.

In some examples, in response to receiving the path switching acknowledgement message including the authorized information, at 850, the BS stores the received authorized information in the UE context for the first UE. The BS can use the UE context including the authorized information for the first UE's SL communications in the scheduled resource allocation mode for the at least one of ranging or SL positioning service.

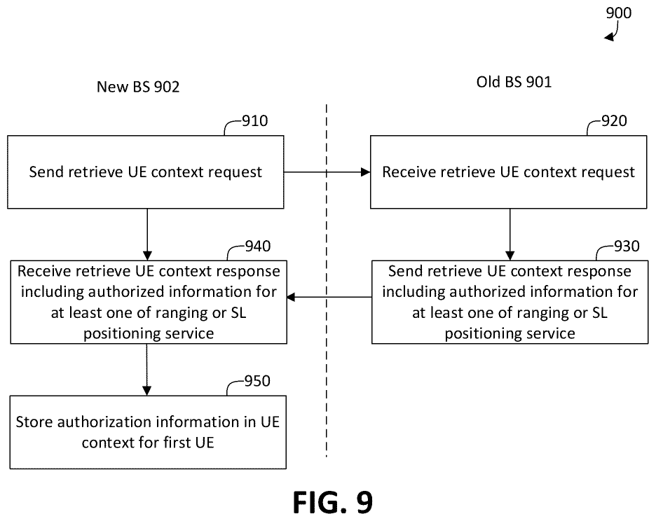

FIG. 9 is a flowchart diagram illustrating an example method 900 for managing authorized information for at least one of ranging or SL positioning service in SL communications for a UE during a retrieve UE context procedure, according to various arrangements. Referring to FIGS. 1A-9, the method 900 can be performed by an old BS 901 and a new BS 902. Each of the BS 901 and 902 can be a BS such as the BS 102 or 210. Communication network or connection between the BS 901 and 902 is shown as the dashed line therebetween. In a retrieve UE context procedure, the new BS 902 for the first UE (e.g., the UE 104a or 200) retrieves the UE context from the old BS 901. The new BS 902 initiates the procedure by sending the retrieve UE context request message to the old BS 901. The old BS 901 responds with the UE context to the new BS 902 with the retrieve UE context response message. In some examples, the authorized information for the at least one of ranging or SL positioning service is included in the UE context in the old BS 901. The first UE and a second UE (e.g., the UE 104b or 230) can communicate via SL communications.

At 910, the new BS 902 sends a retrieve UE context request to the old BS 901. At 920, the old BS 901 receives the UE context request. At 930, in response to receiving the retrieve UE context request, the old BS 901 sends to the new BS 902 a retrieve UE context request including authorized information for at least one of ranging or SL positioning service. At 940, the new BS 902 receives from the old BS 901 the retrieve UE context request including the authorized information for the at least one of ranging or SL positioning service.

In some implementations, as described, the authorized information includes at least one of at least one of ranging or SL positioning service authorization indication for the first UE, ranging and/or SL positioning resource management parameter for the first UE, ranging and/or SL positioning QoS parameter for the first UE, or a type of the first UE for at least one of ranging or SL positioning service.

In some examples, in response to receiving the retrieve UE context request message including the authorized information, at 950, the new BS 902 stores the received authorized information in the UE context for the first UE. The new BS 902 can use the UE context including the authorized information for the first UE's SL communications in the scheduled resource allocation mode for the at least one of ranging or SL positioning service.

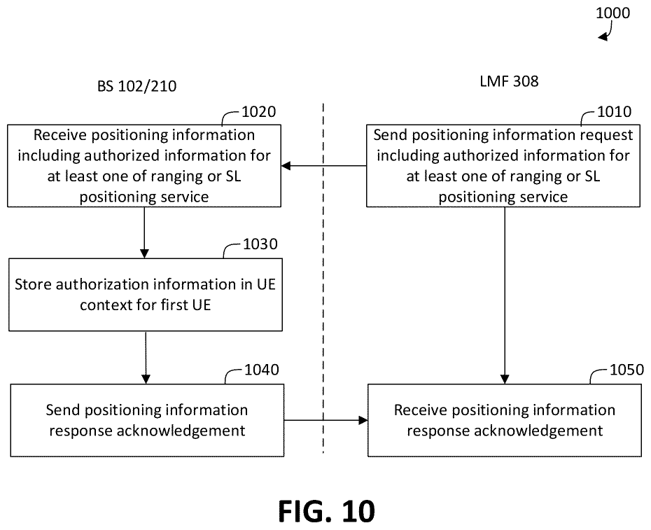

FIG. 10 is a flowchart diagram illustrating an example method 1000 for managing authorized information for at least one of ranging or SL positioning service in SL communications for a UE, according to various arrangements. Referring to FIGS. 1A-10, the method 1000 can be performed by a BS (e.g., the BS 102 or 210) and an LMF (e.g., the LMF 308). Communication network or connection between the BS and the LMF is shown as the dashed line therebetween. In some examples, after the AMF retrieves the authorized information for the UE during the registration procedure, the LMF can obtain the authorization from the AMF. The first UE and a second UE (e.g., the UE 104b or 230) can communicate via SL communications.

For example, at 1010, the LMF sends to the BS a positioning information request including authorized information for at least one of ranging or SL positioning service. At 1020, the BS receives from the LMF the positioning information request including the authorized information for the at least one of ranging or SL positioning service.

In some implementations, as described, the authorized information includes at least one of at least one of ranging or SL positioning service authorization indication for the first UE, ranging and/or SL positioning resource management parameter for the first UE, ranging and/or SL positioning QoS parameter for the first UE, or a type of the first UE for at least one of ranging or SL positioning service.

In some examples, in response to receiving the positioning information request message including the authorized information, at 1030, the BS stores the received authorized information in the UE context for the first UE. The BS can use the UE context including the authorized information for the first UE's SL communications in the scheduled resource allocation mode for the at least one of ranging or SL positioning service.

At 1040, the BS sends to the LMF a positioning information response in response to the positioning information request. At 1050, the LMF receives from the BS the positioning information response.

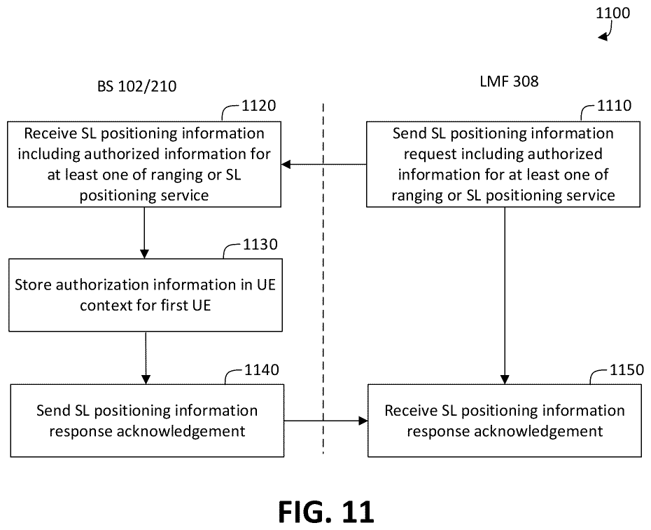

FIG. 11 is a flowchart diagram illustrating an example method 1100 for managing authorized information for at least one of ranging or SL positioning service in SL communications for a UE, according to various arrangements. Referring to FIGS. 1A-11, the method 1100 can be performed by a BS (e.g., the BS 102 or 210) and an LMF (e.g., the LMF 308). Communication network or connection between the BS and the LMF is shown as the dashed line therebetween. In some examples, after the AMF retrieves the authorized information for the UE during the registration procedure, the LMF can obtain the authorization from the AMF. For example, in configuring the ranging and sidelink positioning for the first UE, the LMF includes the authorized information in a SL positioning information request message. The first UE and a second UE (e.g., the UE 104b or 230) can communicate via SL communications.

For example, at 1110, the LMF sends to the BS a SL positioning information request including authorized information for at least one of ranging or SL positioning service. At 1120, the BS receives from the LMF the SL positioning information request including the authorized information for the at least one of ranging or SL positioning service. In some arrangements, the SL positioning information request is part of an SL positioning procedure (request/response) used for SL, which is different from the positioning information procedure. A positioning information procedure (request/response) is a procedure for downlink positioning that is applied to support the SL.

In some implementations, as described, the authorized information includes at least one of at least one of ranging or SL positioning service authorization indication for the first UE, ranging and/or SL positioning resource management parameter for the first UE, ranging and/or SL positioning QoS parameter for the first UE, or a type of the first UE for at least one of ranging or SL positioning service.

In some examples, in response to receiving the SL positioning information request message including the authorized information, at 1130, the BS stores the received authorized information in the UE context for the first UE. The BS can use the UE context including the authorized information for the first UE's SL communications in the scheduled resource allocation mode for the at least one of ranging or SL positioning service.

At 1140, the BS sends to the LMF a SL positioning information response in response to the SL positioning information request. At 1150, the LMF receives from the BS the SL positioning information response.

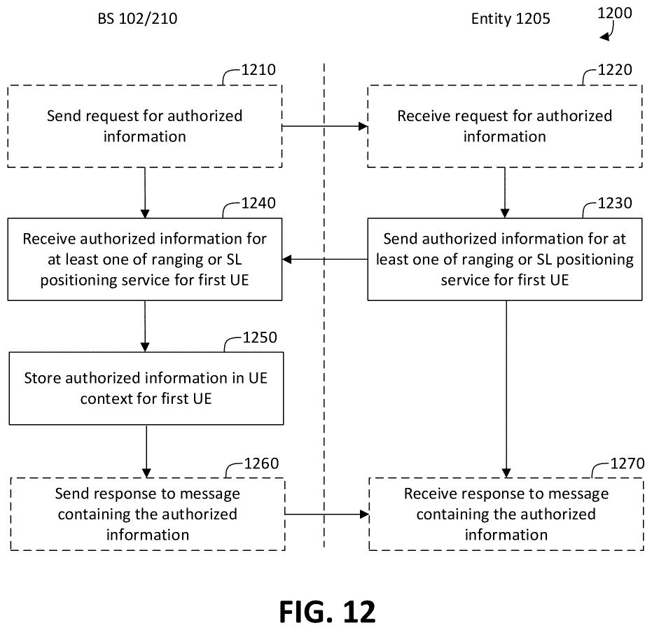

FIG. 12 is a flowchart diagram illustrating an example method 1200 for managing authorized information for at least one of ranging or SL positioning service in SL communications for a UE, according to various arrangements. Referring to FIGS. 1A-12, the method 1200 can be performed by a BS (e.g., the BS 102 or 210) and an entity 1205. The entity 1205 can be at least one of the AMF, source BS in a handover procedure, old BS in a retrieve UE context procedure, or LMF, as described herein. Communication network or connection between the BS and the entity is shown as the dashed line therebetween. The methods 400, 500, 600, 700, 800, 900, 1000, and 1100 are examples of the method 1200.

In some examples, the BS to the entity 1205 sends a request for authorized information at 1210. At 1220, the entity 1205 receives the request for authorized information. Examples of the request includes path switching request, the retrieve UE context request, and so on.

In some examples, the entity 1205 sends to the BS, authorized information for at least one of ranging or SL positioning service for a first UE, at 1230, where the BS receives the same at 1240. At 1250, the BS stores the authorized information in a device context for the first UE.

In some examples, at 1260, the BS sends to the entity 1205 a response to a message containing the authorized information. At 1270, the entity 1205 receives the response to a message containing the authorized information. Examples of the response includes an initial context setup response, a context modification response, a handover request acknowledgement, a position information response acknowledgement, a SL positioning information response acknowledgement, and so on. In some examples, blocks 1210/1220 are alternatives to blocks 1260/1270.

In some examples, the authorized information includes ranging and/or SL positioning service authorization indication for the first UE. The at least one of ranging or SL positioning service authorization indication indicates whether the at least one of ranging or SL positioning service is authorized or unauthorized for the first UE over a reference point.

In some examples, the authorized information includes ranging and/or SL positioning resource management parameter for the first UE, wherein the ranging and/or SL positioning resource management parameter includes an authorized ranging and/or SL positioning parameter used by the BS to manage resources for and to schedule transmissions for the at least one of ranging or SL positioning service for the first UE. In some examples, the ranging and/or SL positioning resource management parameter includes a UE ranging/SL positioning aggregate maximum bit.

In some examples, the authorized information includes ranging and/or SL positioning QoS parameter for the first UE. The ranging and/or SL positioning QoS parameter includes an authorized ranging and/or SL positioning parameter used by the BS to define attributes of a QoS flow of SL communications of the first UE for the at least one of ranging or SL positioning service. In some examples, the ranging and/or SL positioning QoS parameter includes ranging/SL positioning PC5 QoS parameter.

In some examples, the authorized information includes a type of the first UE for the at least one of ranging or SL positioning service. In some examples, the type of the first UE for the at least one of ranging or SL positioning service includes at least one of a target UE, a reference UE, an assistant UE, or a network-assisted UE.

In some examples, the authorized information is received in an initial context setup request from an AMF.

In some examples, the authorized information is received in a context modification request from an AMF, the method further including updating, by the BS, the authorized information in the device context for the first UE.

In some examples, the authorized information is received in a handover request from an AMF.

In some examples, the BS is a target BS in a handover procedure, and authorized information is received in a handover request from a source BS in the handover procedure.

In some examples, the authorized information is received in a path switching request acknowledgement from an AMF.

In some examples, the BS is a new BS in a retrieve UE context procedure, and the authorized information is received in a retrieve UE context response from an old BS in the retrieve UE context procedure.

In some examples, the authorized information is received in a position information request from an LMF.

In some examples, the authorized information is received in a SL position information request from an LMF.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
receiving, by a base station (BS), authorized information for at least one of ranging or Sidelink (SL) positioning service for a first wireless communication device; and
storing, by the BS, the authorized information in a device context for the first wireless communication device.

2. The wireless communication method of claim 1, wherein the authorized information comprises ranging and/or SL positioning service authorization indication for the first wireless communication device, wherein the at least one of ranging or SL positioning service authorization indication indicates whether the at least one of ranging or SL positioning service is authorized or unauthorized for the first wireless communication device over a reference point.

3. The wireless communication method of claim 1, wherein the authorized information comprises ranging and/or SL positioning resource management parameter for the first wireless communication device, wherein the ranging and/or SL positioning resource management parameter comprises an authorized ranging and/or SL positioning parameter used by the BS to manage resources for and to schedule transmissions for the at least one of ranging or SL positioning service for the first wireless communication device.

4. The wireless communication method of claim 3, wherein the ranging and/or SL positioning resource management parameter comprises a User Equipment (UE) ranging/SL positioning aggregate maximum bit.

5. The wireless communication method of claim 1, wherein the authorized information comprises ranging and/or SL positioning Quality of Service (QOS) parameter for the first UE, wherein the ranging and/or SL positioning QoS parameter comprises an authorized ranging and/or SL positioning parameter used by the BS to define attributes of a QoS flow of SL communications of the first wireless communication device for the at least one of ranging or SL positioning service.

6. The wireless communication method of claim 5, wherein the ranging and/or SL positioning QoS parameter comprises ranging/SL positioning PC5 QoS parameter.

7. The wireless communication method of claim 1, wherein the authorized information comprises a type of the first UE for the at least one of ranging or SL positioning service.

8. The wireless communication method of claim 7, where the type of the first wireless communication device for the at least one of ranging or SL positioning service comprises at least one of a target User Equipment (UE), a reference UE, an assistant UE, or a network-assisted UE.

9. The wireless communication method of claim 1, wherein the authorized information is received in an initial context setup request from an Access and Mobility Management function (AMF).

10. The wireless communication method of claim 1, wherein the authorized information is received in a context modification request from an Access and Mobility Management function (AMF), the method further comprising updating, by the BS, the authorized information in the device context for the first wireless communication device.

11. The wireless communication method of claim 1, wherein the authorized information is received in a handover request from an Access and Mobility Management function (AMF).

12. The wireless communication method of claim 1, wherein
the BS is a target BS in a handover procedure; and
the authorized information is received in a handover request from a source BS in the handover procedure.

13. The wireless communication method of claim 1, wherein the authorized information is received in a path switching request acknowledgement from an Access and Mobility Management function (AMF).

14. The wireless communication method of claim 1, wherein
the BS is a new BS in a retrieve UE context procedure; and
the authorized information is received in a retrieve UE context response from an old BS in the retrieve UE context procedure.

15. The wireless communication method of claim 1, wherein the authorized information is received in a position information request from a Location Management Function (LMF).

16. The wireless communication method of claim 1, wherein the authorized information is received in a SL position information request from a Location Management Function (LMF).

17. A base station (BS), comprising:
at least one processor configured to:
receive, via a receiver, authorized information for at least one of ranging or Sidelink (SL) positioning service for a first wireless communication device; and
store the authorized information in a device context for the first wireless communication device.

18. An entity, comprising:
at least one processor configured to:
send, via a transceiver to a base station (BS), authorized information for at least one of ranging or Sidelink (SL) positioning services for a first wireless communication device, wherein the BS stores the authorized information in a device context for the first wireless communication device; and
at least one of:
receive, via the transceiver from the BS, a response to a message containing the authorized information; or
receive, via the transceiver from the BS, a request for the authorized information.

19. A wireless communication method, comprising:
sending, by an entity to a base station (BS), authorized information for at least one of ranging or Sidelink (SL) positioning services for a first wireless communication device, wherein the BS stores the authorized information in a device context for the first wireless communication device;
at least one of:
receiving, by the entity from the BS, a response to a message containing the authorized information; or
receiving, by the entity from the BS, a request for the authorized information.

20. The wireless communication method of claim 19, wherein at least one of:
the entity is an Access and Mobility Management function (AMF);
the entity is a source BS in a handover procedure;
the entity is an old BS in a retrieve UE context procedure; or
the entity is a Location Management Function (LMF).
